(19) United States
(12) Patent Application Publication
(10) Pub. No.: US 2025/0025914 A1
(43) Pub. Date: Jan. 23, 2025

(54) MEMORIAL PRODUCED FROM REMAINS OF PET AND METHOD FOR PRODUCING THE SAME

(71) Applicant: CHAO TE WENG, Taichung City (TW)

(72) Inventor: CHAO TE WENG, Taichung City (TW)

(21) Appl. No.: 18/761,544

(22) Filed: Jul. 2, 2024

(30) Foreign Application Priority Data
Jul. 17, 2023 (TW) 112126610

(51) Int. Cl. B05D 7/24; E04H 13/00

(52) U.S. Cl. CPC B05D 7/24; E04H 13/008; B05D 2601/20

(57) ABSTRACT

A method for producing a memorial from remains of a pet includes steps of: providing a substrate; selecting a part of the remains of the pet, and processing the part into a plurality of small particles; selecting a coating material that can be applied and affixed onto the substrate, and well mixing the particles with the coating material; and applying the coating material onto a surface of the substrate. The memorial carrying a part of remains of a pet can act as an object for an owner of the deceased pet to repose his/her love to the pet and relieve the owner from grieving over the deceased pet. The memorial can be customized to the owner's preferences and accompany the owner as if the pet were still living.

### FIELD OF THE INVENTION

The present invention relates to production of crafts according to the preamble of claim 1. Accordingly, the present invention severally relates to, and more particularly to a memorial produced from remains of a pet and method for producing the same.

### BACKGROUND OF THE INVENTION

In the modern society, people are getting more and more estranged from each other, and the population of solitaries is increasing year by year. Many people instead raise pets to get company they long for. However, time is ruthless, and life is short, particularly when it comes to pets. No matter how hardly owners of pets wish for the pets' long life, they can never refuse death from taking away their love and the consequent feeling of loneliness.

Taiwan Patent Publication No. 536164 has disclosed a ceramic plate decoration having biological bone flour. The ceramic plate decoration is made of porcelain clay that contains bone flour of a deceased pet, and acts as a memorial that not only reminds an owner of the deceased pet but also accompanies the owner in place of the pet. Japan Patent No. JP3112421U and Japan Patent No. JP2006-255367A also relate to decorations made of a mixture of resin and bone flour or hair of pets for remembrance.

However, the aforementioned known techniques are all about making decoration with a mixture of bone ash and potter's clay or resin, so the resulting memorials are essentially restricted in terms of form and appearance. Hence, there is a need for a method for making memorials that specifically cater for individual preferences of pet owners.

### SUMMARY OF THE INVENTION

The primary objective of the present invention is to provide a memorial produced from remains of a pet and method for producing the same as described in the claims. To produce the memorial, small particles derived from a part of remains of a pet are mixed into a coating material and then applied to an object. This means that the form of the memorial is determined by the object, which can be almost anything according to a pet owner's preferences. Thereby, the memorial of the present invention is customizable and easy to make.

In order to achieve the foregoing objective, the present invention provides a method for producing a memorial from remains of a pet, which comprises steps of:
providing a substrate according to a form desired by an owner of the pet;
selecting a part of the remains of the pet, and processing the part into a plurality of small particles;
selecting a coating material that can be applied and affixed onto the substrate, and well mixing the particles with the coating material; and
applying the coating material to a surface of the substrate.

Preferably, the part of the remains of the pet is cremated into powder. The powder is then extracted using diluted hydrochloric acid or nitric acid that has a concentration of 3%˜20%, at a solute-solvent ratio of 1:10˜1:300, for 10-500 minutes so as to obtain carbon element in a form of carbon powder or carbon residue. Afterward, the carbon powder or carbon residue is extracted using a filter solvent, dried, and fined into micrometer- or nanometer-scale small particles.

The invention as well as a preferred mode of use, further objectives and advantages thereof will be best understood by reference to the following detailed description of illustrative embodiments when read in conjunction with the accompanying drawings.

### BRIEF DESCRIPTION OF THE DRAWINGS

FIG. 1 is a flowchart of the method according to a first embodiment of the present invention;

FIG. 2 shows the first embodiment of the present invention;

FIG. 3 is a partial, zoomed-in view of FIG. 2;

FIG. 4 shows the second embodiment of the present invention;

FIG. 5 shows the third embodiment of the present invention; and

FIG. 6 shows the fourth embodiment of the present invention.

### DETAILED DESCRIPTION OF THE INVENTION

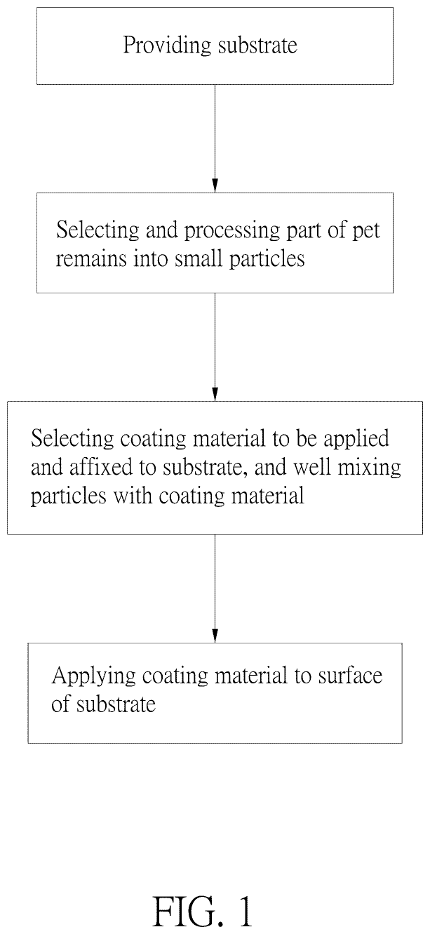

Referring to FIG. 1 through FIG. 3, in the first embodiment of the present invention, the memorial produced form remains of a pet comprises a substrate 1, a coating material 2, and a plurality of particles 3.

The substrate 1 may be a wooden, bamboo, pottery, porcelain, plastic, rubber, metal, glass, colored glaze, crystal, textile, printing, or dyeing craft as selected by an owner of the pet. The coating material 2 is to be applied and affixed to the surface of the substrate 1. The coating material 2 is selected according to the nature of the substrate 1 so that it is a material suitable to be applied onto to substrate 1. The particles 3 are a part of the remains of the pet. The part of the remains of the pet may be bone ash or hair. The particles 3 have a size smaller than one micrometer. Therein, the particles 3 are added into and well mixed with the coating material 2, and then the mixed coating material 2 is applied to the substrate 1 to form a coating layer 4.

FIG. 1 illustrates the steps of the disclosed method for producing a memorial from remains of a pet. As shown, the first step is to discuss with an owner of the pet about the form of the substrate 1 and to provide the desired substrate 1. Secondly, a part of the remains of the deceased pet selected by the owner is processed into small particles 3. In the present embodiment, the remains of the pet are cremated and burned into bone ash by oxidizing flame (with a lower carbon content) or burned into bone char powder by reducing flame (with a higher carbon content). At this time, the bone ash or bone char powder still contains elements like calcium, phosphorus, and potassium. Since different batches of bone ash or bone char powder may have different compositions, extraction is required. To this end, the bone ash or bone char powder is extracted using diluted hydrochloric acid/nitric acid having a concentration of 3%-20% at a solute-solvent ratio of 1:10˜1:300 for 10˜500 minutes so as to extract carbon element. After the reaction, carbon exists in the form of carbon powder or carbon residue. The carbon powder/carbon residue is further extracted using a filter solvent, dried, and fined into micrometer-or nanometer-scale small particle through any of various grinding means, such as crushing, oscillation shattering, ultrasonic waves, and a ball mill, so as to facilitate subsequent procedure and provide the pet owner with more freedom in selecting among materials, results, and manifestations. Afterward, a coating material 2 suitable to be applied and affixed to the substrate 1 is selected. The particles 3 are well mixed with the coating material 2. At last, the coating material 2 is applied to the substrate 1, thereby completing production of the memorial that carries a part of the decease pet.

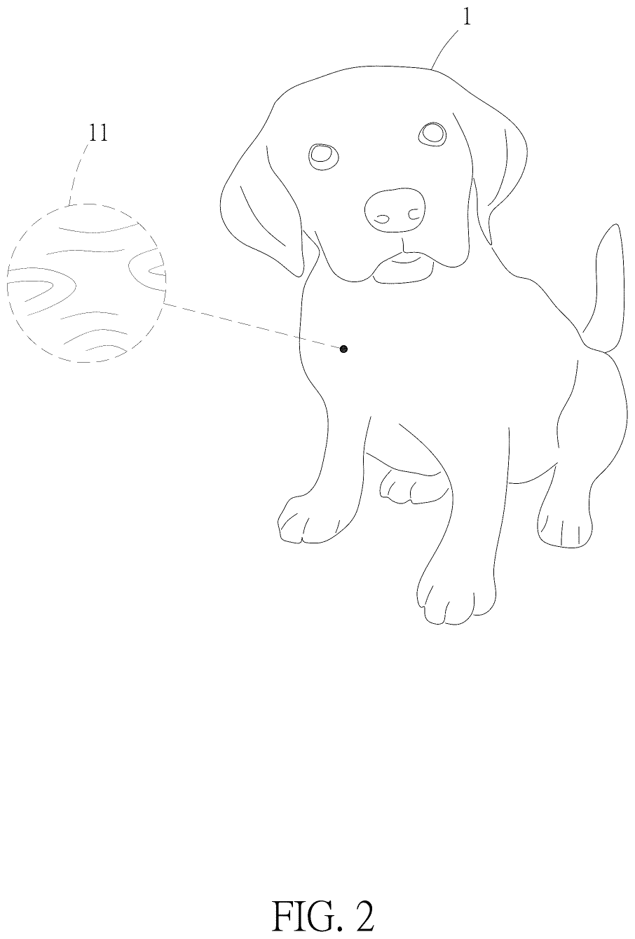

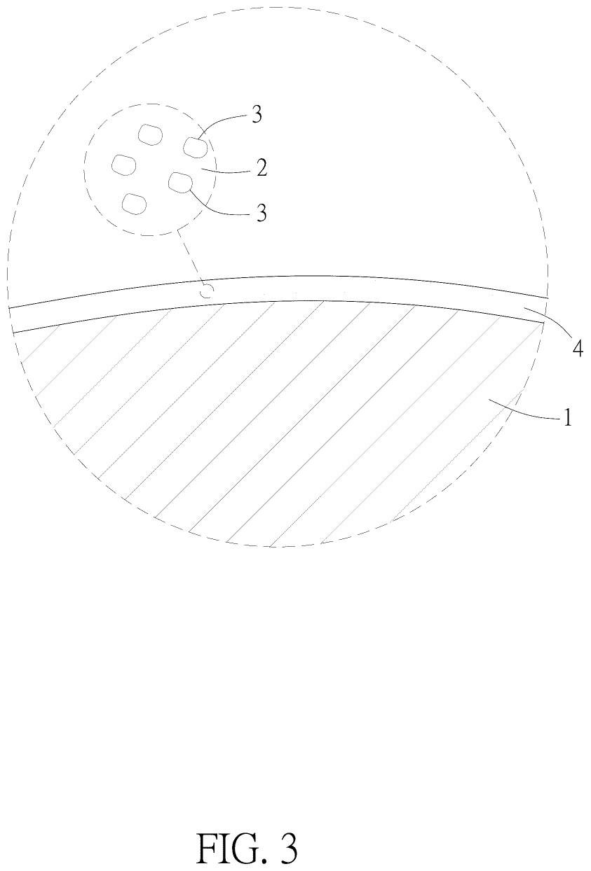

Referring to FIG. 2 and FIG. 3, according to the first embodiment of the present invention, in the memorial produced from remains of a pet, the substrate 1 is a wooden statue of the deceased pet, and the coating material 2 is pigment or paint. Therein, the wooden statue has a grain 11. The pigment is water soluble pigment, such as acrylic paint. The paint may be oil-based pant such as nitrocellulose paint or polyurethane paint, or may be water-based paint. It is to be noted that if the wooden statue is to be colored, a paint-based protective layer has to be applied to the substrate 1 before the pigment is applied, and a further paint-based protective layer is preferably formed over the pigment for color protection, thereby facilitating long-term preservation of the resulting memorial. By mixing small particles 3 of the remains of the pet with the coating material 2 and applying the mixed coating material 2 onto the wooden statue, the resulting memorial carrying a part of remains the deceased pet can act as an object for an owner of the deceased pet to repose his/her love to the pet and relieve the owner from grieving over the deceased pet. Since the form of the memorial and the part of the deceased pet used to produce the memorial are both determined by the pet owner, the memorial of the present invention is genuinely customizable and a true companion accompanying the owner as if the pet were still living.

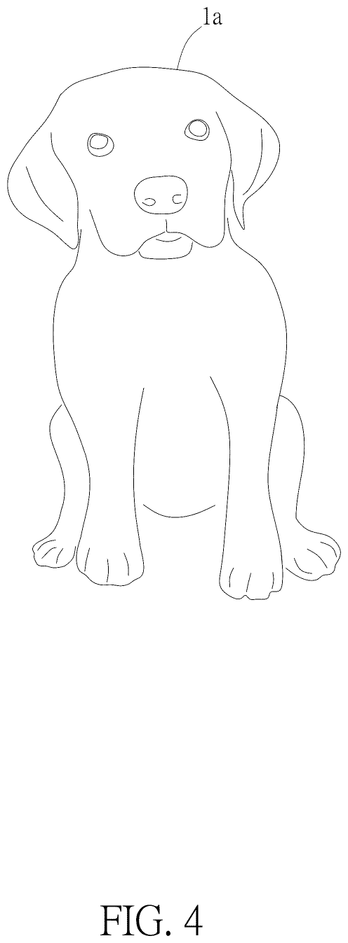

Referring to FIG. 4, according to the second embodiment of the present invention, in the memorial produced from remains of a pet, the substrate la is a clay statue of a deceased pet, and the coating material comprises pigment, paint, or glaze. Therein, the pigment is water soluble pigment, such as acrylic paint, and the paint may be ceramic varnish, color paint, paint powder, paint chips, metal powder, raden, or egg shell, and the glaze may be gloss glaze, luster glaze, or matt glaze. It is to be noted that before the glaze is applied, the substrate la has to be biscuit fired, and after the glaze is applied, glost firing has to be performed to cure the glaze.

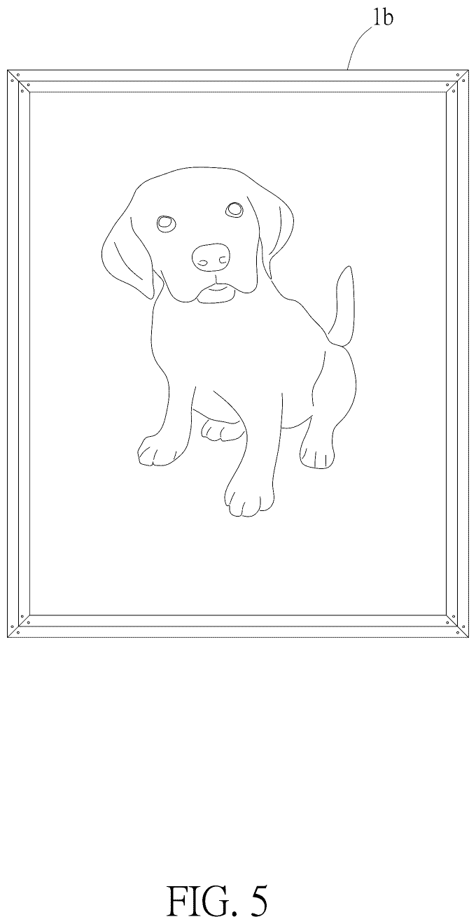

Also referring to FIG. 5, according to the third embodiment of the present invention, in the memorial produced from remains of a pet, the substrate 1b is a painted portrait or a photograph showing the figure of the pet, and the coating material comprises pigment or paint. Therein, the portrait of the pet may be drawn as an acrylic painting or an oil painting, and the photograph of the pet may be presented using inkjet printing, printmaking or screen printing. The pigment may be, for example, acrylic paint, oil paint, or inkjet ink, depending on how the portrait is drawn or how the photograph is printed. The portrait may be further protected with varnish or other protective paint.

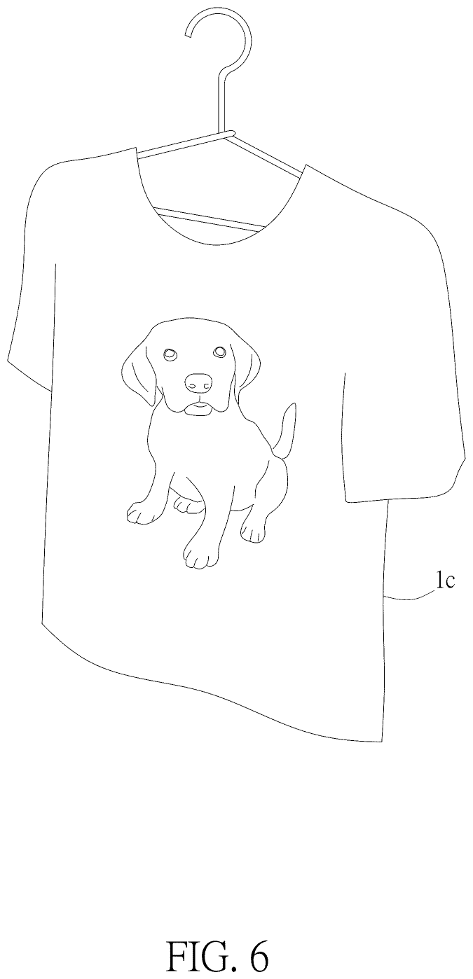

Also referring to FIG. 6, according to the fourth embodiment of the present invention, in the memorial produced from remains of a pet, the substrate 1c is a woven article patterned with appearance of the pet, and the coating material comprises pigment. Therein, the woven article is a piece of clothing printed with appearance of the pet. In other embodiments, the woven article may alternatively be a fiber product made of a fiber material. The appearance of the pet may be printed on the clothing using lithography, direct inkjet printing, thermal transfer, or sublimation printing. The pigment may comprise water-based ink, solvent-based ink, or UV ink.

With the method of the present invention, small particles 3 of remains of a pet mixed into the coating material 2 are applied to the substrate 1 to make the resulting memorial carry a part of the deceased pet. Particularly, the form of the memorial is arbitrary in nature so that a pet owner can keep a part of his/her deceased pet in a preferred form. Thereby, the memorial of the present invention is customizable and easy to make.

What is claimed is:

1. A method for producing a memorial from remains of a pet, being characterized in comprising steps of:
determining a form of the memorial through discussion with an owner of the pet and providing a substrate according to the determined form;
selecting a part of the remains of the pet, and processing the part into a plurality of small particles;
selecting a coating material that can be applied and affixed to the substrate, and well mixing the particles with the coating material; and
applying the coating material to a surface of the substrate.

2. The method of claim 1, being characterized in that the part of the remains of a pet is first cremated into powder, extracted using diluted hydrochloric acid or nitric acid that has a concentration of 3%˜20%, at a solute-solvent ratio of 1: 10˜1:300, for 10-500 minutes so as to obtain carbon element in a form of carbon powder or carbon residue, which is further extracted using a filter solvent, dried, and fined into micrometer-or nanometer-scale small particles.

3. A memorial of a pet produced using the method of claim 1, being characterized in comprising:
a substrate;
a coating material, for being applied and affixed to a surface of the substrate; and
a plurality of small particles made of a part of remains of the pet;
wherein the particles are added into the coating material and then the coating material containing the particles is applied to the substrate to form a coating layer on the surface of the substrate.
